(19) United States
(12) Patent Application Publication
(10) Pub. No.: US 2016/0116974 A1
(43) Pub. Date: Apr. 28, 2016

(54) METHODS AND SYSTEMS TO BOOT UP SMARTPHONES IN ULTRA LOW POWER MODES

(71) Applicant: QUALCOMM Incorporated, San Diego, CA (US)

(72) Inventors: Vani Chaitanya GINNELA, College Station, TX (US); Praveen Nagaraja KONA, Hyderabad (IN); Phani Bhushan AVADHANAM, San Diego, CA (US)

(21) Appl. No.: 14/607,037

(22) Filed: Jan. 27, 2015

Related U.S. Application Data
(60) Provisional application No. 62/067,935, filed on Oct. 23, 2014.

(51) Int. Cl. G06F 1/32; G06F 9/44

(52) U.S. Cl. CPC G06F 1/3293; G06F 1/3287; G06F 1/3212; G06F 9/4401

(57) ABSTRACT

Systems and methods for booting up a mobile device involve segmenting a boot sequence of the mobile device into a plurality of boot sequence segments and determining a first boot sequence segment from the plurality of boot sequence segments, battery power consumed by the first boot sequence segment exceeds a predetermined battery power threshold. In addition, systems and methods further include selecting a target boot mode from a plurality of boot modes. The target boot mode is configured to be executed when the first boot sequence segment of the boot sequence is to be executed, and each of the plurality of boot modes corresponds to at least some but not all resources of the mobile device. Furthermore, systems and methods involve executing the first boot sequence segment based on the target boot mode and executing at least one of the plurality of boot sequence segments other than the first boot sequence segment based on a normal mode. The normal mode corresponds to all resources of the mobile device.

### CROSS-REFERENCE TO RELATED APPLICATION(S)

This application claims the benefit of U.S. Provisional Application Ser. No. 62/067,935, entitled “METHODS AND SYSTEMS TO BOOT UP SMARTPHONES IN ULTRA LOW POWER MODES” and filed on Oct. 23, 2014, which is expressly incorporated by reference herein in its entirety.

### BACKGROUND

1. Field

Embodiments described herein generally relate to methods and systems for booting up a mobile device, and particular embodiments relate to methods and systems for booting up the mobile device in at least one modified boot mode.

2. Background

Various applications have been developed to extend battery life of a mobile device (e.g., a smartphone, a tablet, or the like) by automatically turning off or customizing device resources (e.g., applications, features, functions, and/or the like) to reduce or prevent further battery drain. By turning off resources, battery power can be conserved, but with the loss of the off resources. Still, conserving battery power may be crucial in a situation where a small percentage of the battery power is remaining. For example, the mobile device's display brightness, background data synchronization, Wi-Fi, and BlueTooth may be adjusted or even disabled when the battery power level reaches a predefined threshold at the application layer.

In addition, the mobile device may be manually or automatically switched off or switched to a hibernation mode when the battery power of the mobile device reaches a predetermined threshold. At extremely low battery power levels, a user may choose to shut off the mobile device when not in use, and temporarily turn it back on when desired, to use certain feature(s) of the mobile device. This may occur when the power-saving applications discussed can no longer save enough battery power for the mobile device to remain powered on for long.

However, when the mobile device is powered on at low battery power levels, the mobile device is initialized for all features (e.g., including controllers/drivers for telephonic communication, short message service, Wi-Fi, BlueTooth, camera, display, and the like). In other words, the regular boot sequence of the mobile device would not take into account the user's need in the context of low battery power levels. Instead, the regular or normal boot sequence of the mobile device may initialize the mobile device in a regular manner, as if the mobile device is not subject to battery power constraints (i.e., the mobile device may be initialized for all potential user needs).

### SUMMARY

Various embodiments generally relate to booting up or initializing a mobile device in at least one of various boot modes. For example, a process for booting up a mobile device is described according to various embodiments. The process including: segmenting a boot sequence of the mobile device into a plurality of boot sequence segments; determining a first boot sequence segment from the plurality of boot sequence segments, battery power consumed by the first boot sequence exceeding a predetermined battery power threshold; selecting a target boot mode from a plurality of boot modes, such that the target boot mode is configured to be executed when the first boot sequence portion of the boot sequence is to be executed, and each of the plurality of boot modes corresponds to at least some but not all resources of the mobile device; executing the first boot sequence segment based on the target boot mode; and executing at least one of the plurality of boot sequence segments other than the first boot sequence segment based on a normal mode, the normal mode corresponding to all resources of the mobile device.

According to some embodiments, the segmenting the boot sequence includes monitoring, for each of the plurality of boot sequence segments, battery power consumption associated with at least one boot instance; determining, for each of the plurality of boot sequence segments, battery power consumption characteristics based on the battery power consumption associated with the at least one boot instance; and determining the first boot sequence segment based, at least in part, on the battery power consumption characteristics.

In some embodiments, the process further includes determining a second boot sequence segment from the plurality of boot sequence segments, time consumed by the second boot sequence exceeds a predetermined temporal threshold; and executing the second boot sequence segment based on the target boot mode.

In various embodiments, the segmenting the boot sequence includes monitoring, for each of the plurality of boot sequence segments, time consumption associated with two or more boot instances; determining, for each of the plurality of boot sequence segments, time consumption characteristics based on the time consumption associated with the two or more boot instances; and determining the second boot sequence segment based, at least in part, on the time consumption characteristics.

According to some embodiments, the process further includes determining a triggering event. The target boot mode is selected in response to the triggering event being detected. The triggering event is at least one of a battery of the mobile device dropping below predetermined battery power level, a rate of power consumption exceeding a predetermined power consumption threshold, and a location of the mobile device being with a predetermined area.

In some embodiments, the process further includes monitoring battery power consumed during the boot sequence and an operational phase of the mobile device; determining a boot mode power estimate number associated with the target mode based on the monitored battery power consumed; and displaying the boot mode power estimate number with the target mode.

Various embodiments further includes monitoring battery power consumed during boot sequences and an operational phases of the mobile device associated with each of the plurality of boot modes; determining a plurality of boot mode power estimate numbers based on the monitored battery power consumed during the boot sequences and the operational phases of the mobile device associated with each of the plurality of boot modes, each boot mode power estimate number corresponding to a corresponding boot mode of the plurality of boot modes; and displaying each of the plurality of boot mode power estimate numbers with the corresponding boot mode.

In some embodiments, the plurality of boot sequence modes includes two or more of an emergency mode, a voice-only mode, a text-only mode, a data-only mode, a location-only mode, and a normal mode. The emergency mode enables initialization of at least one of resources associated with a modem, vocoder, telephony services, at least one dialer application, at least one SOS-based application, and at least one location-based application.

Furthermore, in some embodiments, the voice-only mode enables initialization of at least one of resources associated with a modem, vocoder, Wi-Fi, at least one dialer application, and at least one contact application.

In addition, in various embodiments, the text-only mode enables initialization of at least one of resources associated with a modem, vocoder, at least one short message service (SMS) application, and at least one contact application.

In some embodiments, the data-only mode enables initialization of at least one of resources associated with a modem, Wi-Fi, and at least one application requiring data. Further, the location-only mode enables initialization of at least one of resources associated with a geo-location device, Wi-Fi, modem, and at least one map application. Still further, the normal mode enables initialization of all hardware and software resources of the mobile device.

In some embodiments, the process further includes executing at least one prior boot sequence segment prior in the boot sequence to the first boot sequence segment. The first boot sequence segment is executed at the completion of executing the at least one prior boot sequence segment.

In various embodiments, the process further includes executing at least one subsequent boot sequence segment subsequent in the boot sequence to the first boot sequence segment. The at least one subsequent boot sequence segment is executed at the completion of executing the first boot sequence segment.

In some embodiments, an apparatus for booting up a mobile device is described. The apparatus includes: means for segmenting a boot sequence of the mobile device into a plurality of boot sequence segments; means for determining a first boot sequence segment from the plurality of boot sequence segments, battery power consumed by the first boot sequence exceeding a predetermined battery power threshold; means for selecting a target boot mode from a plurality of boot modes, such that the target boot mode is configured to be executed when the first boot sequence portion of the boot sequence is to be executed, and each of the plurality of boot modes corresponds to at least some but not all resources of the mobile device; means for executing the first boot sequence segment based on the target boot mode; and means for executing at least one of the plurality of boot sequence segments other than the first boot sequence segment based on a normal mode, the normal mode corresponding to all resources of the mobile device.

According to various embodiments, a non-transitory computer-readable medium containing program instructions is described. When executed, the instructions cause the computer to: segment a boot sequence of the mobile device into a plurality of boot sequence segments; determine a first boot sequence segment from the plurality of boot sequence segments, battery power consumed by the first boot sequence exceeding a predetermined battery power threshold; select a target boot mode from a plurality of boot modes, such that the target boot mode is configured to be executed when the first boot sequence portion of the boot sequence is to be executed, and each of the plurality of boot modes corresponds to at least some but not all resources of the mobile device; execute the first boot sequence segment based on the target boot mode; and execute at least one of the plurality of boot sequence segments other than the first boot sequence segment based on a normal mode, the normal mode corresponding to all resources of the mobile device.

In various embodiments, the computer is further caused to monitor, for each of the plurality of boot sequence segments, battery power consumption associated with two or more boot instances; determine, for each of the plurality of boot sequence segments, battery power consumption characteristics based on the battery power consumption associated with the two or more boot instances; and determine the first boot sequence segment based, at least in part, on the battery power consumption characteristics.

### BRIEF DESCRIPTION OF THE DRAWINGS

FIG. 1 is a schematic diagram illustrating an example of a mobile device bootup system according to various embodiments.

FIG. 2 is a process flowchart of a power-hungry and/or time-consuming boot sequence segment determination process according to various embodiments.

FIG. 3 is a process flowchart of a modified boot sequence process is illustrated according to various embodiments.

FIG. 4 is a process flowchart of an example process illustrated according to various embodiments.

FIG. 5 is an example of a mode selection screen illustrated suitable for implementation for various embodiments.

FIG. 6 is an example of an emergency mode home screen illustrated suitable for implementation for various embodiments.

FIG. 7 is an example of an voice-only mode home screen illustrated suitable for implementation for various embodiments.

FIG. 8 is an example of an data-only mode home screen illustrated suitable for implementation for various embodiments.

FIG. 9 is an example of an location-only mode home screen illustrated suitable for implementation for various embodiments.

FIG. 10 is a process flowchart of an example of a power-based boot sequence illustrated according to various embodiments.

FIG. 11 is a functional block diagram of a mobile device according to various embodiments of the disclosure.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the invention or the claim.

Embodiments described herein are directed to shortening boot time and conserving power for a boot sequence initiated to boot up a mobile device. Particular embodiments are directed to customizing the boot sequence of the mobile device based on the intended function of the mobile device, when the mobile device is booted up after being powered off (e.g., due to lack of battery power). According to various embodiments, the boot sequence may be modified based on a triggering event. The triggering event may be a low battery power level (e.g., when the battery power level of the mobile device reaches a predetermined threshold), fast battery power drain (e.g., when the battery power drain exceeds a predetermined threshold), and/or the like. Other types of triggering events (e.g., user input, the mobile device being located at a predetermined location or within a predetermined area, and/or the like) may also be applied to trigger the modified boot sequence.

In general, the modified boot sequence may refer to at least a portion of the mobile device's hardware/software resources/drivers being disabled or otherwise not initiated during the modified bootup sequence. The mobile device may initialize some resources/drivers of the mobile device based on needs of the user (i.e., the purpose that the user had in mind) when the mobile device is booted up. Accordingly, all resources/drivers enabled by the modified boot sequence are used, with no or few background applications running or at standby. For example, very few or no background software (software that is running but is not actively and/or directly used by the user) may be running once the mobile device has been booted up according to the modified boot sequence. The resources/drivers as referred to herein relate to initializing both the software and the hardware components implemented to realize some functions or features of the mobile device.

A plurality of boot modes may be defined (e.g., predefined by designated programmers or the original equipment manufacturer) for the mobile device. Each of the plurality of the boot modes may correspond to at least one function or feature of the mobile device. Such boot modes may include an emergency mode, voice-only mode, text-only mode, data-only mode, location-only mode, a normal mode, a combination thereof, and/or the like. A target boot mode may refer to at least one of the plurality of boot modes selected to be used to boot the mobile device (e.g., in the modified boot sequence). In other words, the mobile device may be booted up based on the target boot mode. The target boot mode may correspond to the intended use of the mobile device when the mobile device is booted up or switched on by the user of the mobile device. The target boot mode may be selected manually by the user in some embodiments through a user interface of the mobile device. In further or additional embodiments, the target boot mode may be selected automatically based at least in part on various predetermined logic as described herein.

In some embodiments, the complete boot sequence of the mobile device may be segmented into various boot sequence segments (e.g., segments of one or more steps). The mobile device may be configured to monitor each boot sequence segment during previous instances of boot up (referred to herein as boot instances) and assess the battery power consumption and/or time consumption for executing each particular boot sequence segment. At least one boot sequence segment requiring the most (or greater than a predefined amount of) battery power consumption and/or time to complete may be identified. The at least one boot sequence segment requiring the most battery power (or more than a predetermined threshold level) to complete may be referred to as power-hungry segment(s). The at least one boot sequence segment requiring the most time (or more than a predetermined threshold level) to complete may be referred to as time-consuming segment(s).

The mobile device may be configured to execute (or not execute) one or more of the power-hungry segment(s) and/or the time-consuming segment(s) based on the target boot mode. Accordingly, improved efficiency may be achieved by the embodiments described herein (e.g., by targeting the power-hungry and/or the time-consuming boot sequence segments of the boot sequence). Battery power and time consumed during boot up is kept at minimum given that no extra hardware/software resources (that will not be needed for the target mode) are initialized during the modified boot sequence. In addition, battery power consumed during operations of the mobile device after being booted up in the modified boot sequence may also be minimized given that no or few background applications can be executed (because the hardware/software resources corresponding to the background applications are not initialized during the modified boot sequence).

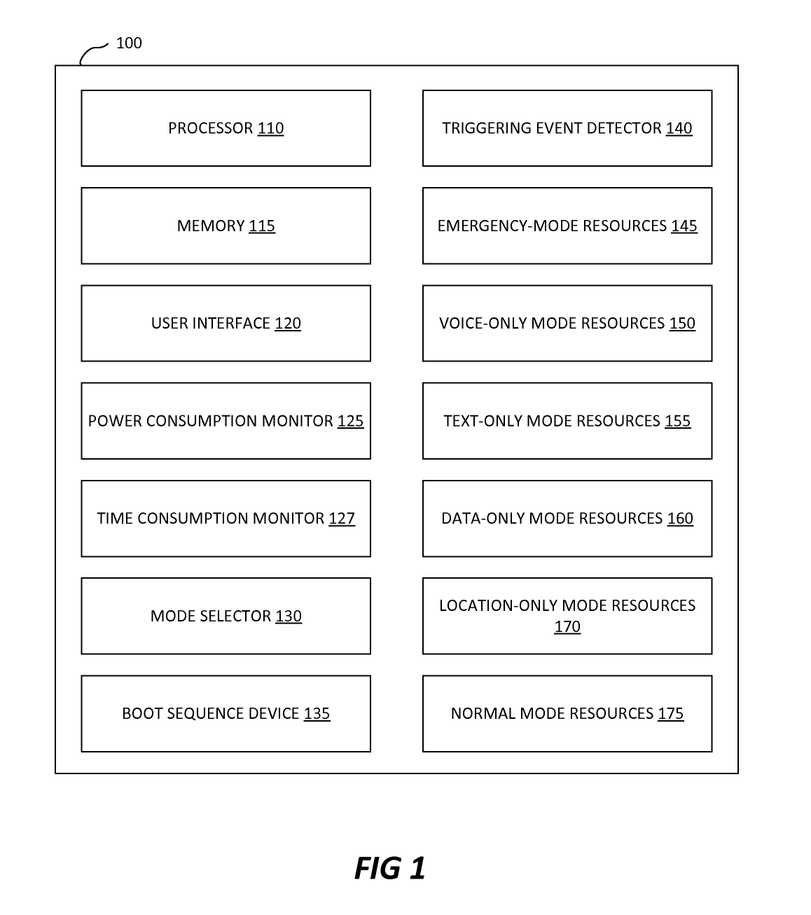

With reference to FIG. 1, a block diagram illustrating an example of a mobile device 100 suitable for implementing a modified boot process for a mobile device is shown in accordance with various embodiments. The mobile device 100 may include at least a processor 110, memory 115, user interface 120, power consumption monitor 125, time consumption monitor 127, mode selector 130, boot sequence device 135, triggering event detector 140, emergency-mode resources 145, voice-only mode resources 150, text-only mode resources 155, data-only mode resources 160, location-only mode resources 170, normal mode resources 175, and/or the like.

The mobile device 100 may refer to one of a cellular telephone, smart phone, personal or mobile multi-media player, personal data assistant, laptop computer, personal computers, tablet computer, smart book, palm-top computer, wireless electronic mail receiver, multimedia Internet-enabled cellular telephone, wireless gaming controller, and similar personal electronic device, a programmable processor, memory, and circuitry for connecting to one or more mobile communication networks (simultaneously or sequentially).

The processor 110 may include any suitable data processing device, such as a general-purpose processor (e.g., a microprocessor). In the alternative, the processor 110 may be any conventional processor, controller, microcontroller, state machine, and/or the like. The processor 110 may also be implemented as a combination of computing devices, e.g., a combination of a DSP and a microprocessor, a plurality of microprocessors, at least one microprocessor in conjunction with a DSP core, and/or any other such configuration. In various embodiments described, the processor may be configured to perform the functions described herein. Specifically, the processor 110 may be included as a part of the power consumption monitor 125, the time consumption monitor 127, the mode selector 130, the boot sequence device 135, the triggering event detector 140, and/or the like for the functions described with respect to those components.

The memory 115 may be operatively coupled to the processor 110 and may include any suitable device for storing software and data for controlling and use by the processor to perform operations and functions described herein. Examples of the memory 115 may include, but not limited to, random access memory (RAM), read only memory (ROM), floppy disks, hard disks, dongles or other USB-connected memory devices, and/or the like. The memory 115 may be configured to store various data and computer-readable instructions executable by the processor 110. Specifically, the memory 115 may be included as a part of the power consumption monitor 125, the time consumption monitor 127, the mode selector 130, the boot sequence device 135, the triggering event detector 140, and/or the like to store data and information for those components.

The user interface 120 may include at least a display device. The display device may include any suitable device that provides a human-perceptible visible signal, audible signal, tactile signal, or any combination thereof, including, but not limited to a touchscreen, LCD, LED, CRT, plasma, other suitable display screen, audio speaker, other audio generating device, combinations thereof, and/or the like.

In some embodiments, the user interface 120 of the mobile device 100 may further include at least one user input device configured to provide an interface for the users to interact with the applications executed on the mobile device 100. The user input device may include any suitable device that receives input from the user including, but not limited to, one or more manual operators (such as, but not limited to a switch, button, touchscreen, knob, slider or the like), microphone, camera, image sensor, or the like.

The user interface 120 may be configured to display a rudimentary graphic user interface (GUI). In some embodiments, the mobile device 100 may display, through the user interface 120, the rudimentary GUI immediately following the powering up of the mobile device 100 and/or when the mobile device 100 has already been booted up in one of the boot modes. For example, in response to detecting a triggering event (e.g., by the triggering event detector 140), the rudimentary GUI may be displayed. The rudimentary GUI may be displayed in response to a boot mode (e.g., any boot modes described other than the normal mode, such as the emergency mode, the voice-only ode, the text-only mode, the data-only mode, the location-only mode, and/or the like) being selected as the target boot mode.

The rudimentary GUI may be offered to display information to the user and receive user input. The rudimentary GUI may consume less battery power and require less initiation time at boot up (e.g., in the modified boot sequence) than a regular GUI. The rudimentary GUI may be less graphic-intensive (e.g., the rudimentary GUI may be less bright, include less or no animated graphics, use limited number of colors such as only black and white, include blockier text and graphics, disable sound/microphone, and/or the like). The rudimentary GUI may be displayed by the user interface 120 during boot up (e.g., when the mobile device 100 displays certain information to the user during boot up or when the mobile device 100 receives input from the user during boot up). In a particular example, the rudimentary GUI may receive user selection of a boot mode following the powering on of the mobile device 100. In other or further embodiments, the rudimentary GUI may be used as the default GUI for user interaction once the mobile device 100 has been booted up in the modified boot sequence. In other words, the user interface 120 may present the rudimentary GUI to the user when the mobile device 100 becomes operational (i.e., after the mobile device 100 becomes booted up based on at least one of the boot modes described).

The power consumption monitor 125 may be a device configured to monitor the power consumed by each boot sequence segment during the modified boot sequence (boot up). In various embodiments, the power consumption monitor 125 may include a processor and/or a memory device coupled to the processor for monitoring the power consumed by each boot sequence segment. For example, the processor may determine the power consumed by a boot sequence segment at least once during at least one boot instance (i.e., a boot up process in which the mobile device 100 is booted up). The data value indicating a battery power consumed during the boot up process may be stored in the memory device. Such process may be repeated multiples times for a plurality of boot instances (a plurality of times of the mobile device 100 being booted up). Thus, a plurality of data values representing battery power consumed for each boot instance may be stored within the memory device. An average power consumption of each boot sequence segment may accordingly be calculated from the plurality of data values stored for each boot sequence segment.

Time consumption monitor 127 may be a device configured to monitor the time consumed by each boot sequence segment during boot up. In various embodiments, the time consumption monitor 127 may include a processor and/or a memory device coupled to the processor for monitoring the time consumed by each boot sequence segment. For example, the processor may determine the time consumed by a boot sequence segment for at least one boot instance. The data value indicating a time consumed for the boot sequence may be stored in the memory device. Such process may be repeated multiples times for a plurality of boot instances. Thus, a plurality of data values representing time consumed for each boot instance may be stored within the memory device. An average time consumption of each boot sequence segment may accordingly be calculated from the plurality of data values stored for each boot sequence segment.

The processor of the power consumption monitor 125 and/or the time consumption monitor 127 may be the processor 110 of the mobile device 100. The memory device of the power consumption monitor 125 and/or the time consumption monitor 127 may be the memory 115 of the mobile device 100. In alternative embodiments, the power consumption monitor 125 and/or the time consumption monitor 127 may include separate processor(s) and/or memory device(s) such as, but not limited to, the processor 110 and the memory device 115 as described, respectively.

The mode selector 130 may be configured to select at least one target boot mode of the plurality of boot modes. In various embodiments, the mode selector 130 may include or otherwise be coupled to at least the user interface 120 as described. The mode selector 130 may prompt a user of the mobile device 100, with the user interface 120, to select a boot mode from a plurality of available boot modes. For example, the user interface 120 may display various user interactive elements representing various different boot modes. The user may select, with the user interface 120, the target boot mode(s) by selecting the corresponding interactive element(s). In other embodiments, the mode selector 130 may include additional and/or separate user interface such as, but not limited to, the user interface 120.

In some embodiments, the mode selector 130 may include at least a processor and/or memory to select the at least one target boot mode. The processor may be the processor 110 or a processor such as, but not limited to, the processor 110. The memory may be the memory 115 or a memory device such as, but not limited to, the memory 115. In various embodiments, the mode selector 130 may be configured to automatically select one of the plurality of modes based on predetermined logic.

For example, the mode selector 130 may select the target boot mode based on historic usage of the mobile device 100 by the user when the mobile device 100 reaches a predetermined battery power level and/or when the mobile device may be determined within a predetermined area (or associated with a predetermined position). In particular, the mode selector 130 may select the emergency mode when the user selects the emergency mode at least a predetermined percentage of times when the mobile device 100 reaches a predetermined battery power level (e.g., 15%, 10%, 5%, 2%, and/or the like). In various embodiments, the mode selector may select the emergency mode when the mobile device reaches a predetermined battery power level (e.g., 15%, 10%, 5%, 2%, and/or the like) and the mobile device 100 is determined to be in a dangerous area (e.g., a mountainous area, freeway outside of the city, and/or the like).

In some embodiments, the boot sequence device 135 may include the processor 110 and the memory 115 for booting up or initializing the mobile device 100. Booting, boot sequence, booting process, and the like may refer to a process where the mobile device 100 (through the boot sequence device 135) may initialize for the features performable by the mobile device 100. As a result, the mobile device 100 may become functional with respect to those features initialized during the boot sequence. In various embodiments, the boot sequence may be segmented into boot sequence segments. The boot sequence device 135 may execute the boot sequence segments in a sequential manner. By way of illustrating with a non-limiting example, a boot sequence may be segmented into boot sequence segments including, but not limited to, 1) power on and boot ROM code execution, 2) bootloader, 3) kernel, 4) initialization process, 5) Zygote and Dalvik, 6) system server, and 7) boot completion. In alternative embodiments, the boot sequence device 135 may include separate processor(s) and/or memory device(s) such as, but not limited to, the processor 110 and the memory device 115 as described.

In various embodiments, the triggering event detector 140 may include the processor 110 and/or the memory 115 for detecting a triggering event. The triggering event may be the battery power level of the mobile device 100 reaching a predetermined threshold. In other embodiments, the triggering event may be the battery power drain of the mobile device 100 exceeding a predetermined threshold. Thus, the triggering event detector 140 may be coupled to a battery (e.g., a battery pack) of the mobile device 100 for detecting the battery power level remaining and battery power drain as described. In addition, the triggering event detector 140 may be coupled to the user interface 120 for receiving user input. User input may also be a triggering event.

In some embodiments, the emergency-mode resources 145 may include both hardware and software required for the emergency-mode to be functional. The emergency mode is one of the plurality of boot modes selectable as the target boot mode. For example, the emergency-mode resources 145 may include resources/drivers of modem, vocoder, and/or the like. In some embodiments, the resources enabled may correspond to emergency communications services, such as emergency dialer, SOS/location-based emergency mobile applications, and/or the like. When the mobile device 100 is initialized based on the emergency mode, the emergency-mode resources 145 may be initialized.

In some embodiments, the voice-only mode resources 150 may include both hardware and software required for the voice-only mode to be functional. The voice-only mode is one of the plurality of boot modes selectable as the target boot mode. For example, the voice-only mode resources 150 may include resources/drivers of modem, vocoder, and Wi-Fi, and/or the like. In some embodiments, the resources enabled may correspond to telephonic communication services, such as dialer applications with relevant contact information enabled, and/or the like.

In some embodiments, the text-only mode resources 155 may include both hardware and software required for the text-only mode to be functional. The text-only mode is one of the plurality of boot modes selectable as the target boot mode. For example, the text-only mode resources 155 may include resources/drivers of modem, vocoder, Wi-Fi, and/or the like. In some embodiments, the resources enabled may correspond to messaging services, such as short message services (SMS) with relevant contact information enabled, and/or the like.

In some embodiments, the data-only mode resources 160 may include both hardware and software required for the data-only mode to be functional. The data-only mode is one of the plurality of boot modes selectable as the target boot mode. For example, the data-only mode resources 160 may include resources/drivers of modem, Wi-Fi, and/or the like. In some embodiments, the resources enabled may correspond to data services, such web browser applications, map applications based on data, various mobile device applications requiring data, and/or the like.

In some embodiments, the location-only mode resources 170 may include both hardware and software required for the location-only mode to be functional. The location-only mode is one of the plurality of boot modes selectable as the target boot mode. For example, the location-only mode resources 170 may include resources/drivers of geo-location system, Wi-Fi, modem, and/or the like. In particular, the location-only mode resources 170 may include hardware and software for determining geographic location of the mobile device 100, such as, but not limited to a global positioning system (GPS) or other satellite positioning system, terrestrial positioning system, Wi-Fi location system, combinations thereof, or the like. In some embodiments, the resources enabled may correspond to location services, such as real-time mapping services, mapping services and/or the like.

In some embodiments, the normal mode resources 175 may include both hardware and software required for the normal mode to be functional. When booting up in the normal mode, the mobile device may be initiated based on its existing default boot up procedures. In other words, all resources/drivers corresponding to all features of the mobile device may be initialized. The normal mode is one of the plurality of boot modes selectable as the target boot mode. For example, the normal mode resources 175 may include resources/drivers for the modem, vocoder, geo-location system, Wi-Fi resources/drivers, and/or the like. In some embodiments, the resources enabled may correspond to all applications/services installed on the mobile device.

According to various embodiments, all modes (e.g., the emergency mode, the voice-only mode, the text-only mode, the data-only mode, the location-only mode, and/or the like) except the normal mode may correspond to booting up some but not all of the resources/drivers of the mobile device 100. In some embodiments, only one of the modes may be selected (e.g., only one of the modes may be selectable by the user through the user interface 120, only one of the modes may be automatically selected by the mode selector 130, and/or the like). In other embodiments, two or more of the modes may be selected (e.g., two or more of the modes may be selectable by the user through the user interface 120, two or more of the modes may be automatically selected by the mode selector 130).

In some embodiments, at least a portion of one set of the mode resources described above may be the same as a portion of another set of the mode resources. For example, the same vocoder resources/drivers may be initialized during boot up for the emergency mode, the voice-only mode, the text-only mode, and the normal mode. Where two or more modes may be initiated in combination, the same set of overlapping resources only need to be initiated once overall.

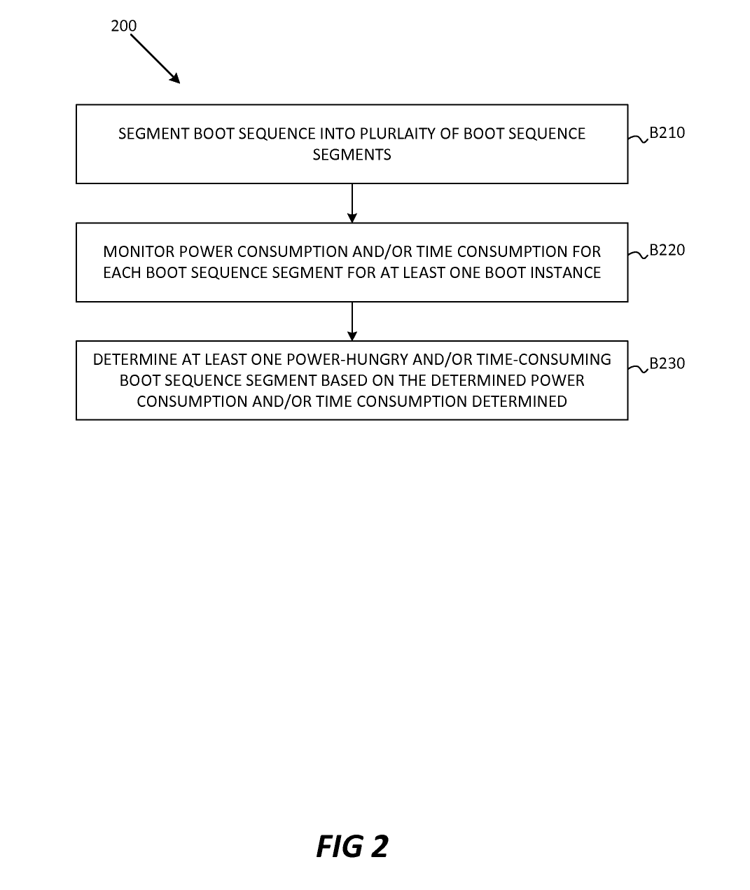

A process flowchart of a power-hungry and/or time-consuming boot sequence segment determination process 200 is illustrated in FIG. 2 according to various embodiments. With reference to FIGS. 1-2, first at block B210, the boot sequence of the mobile device 100 may be segmented into a plurality of boot sequence segments. The boot sequence may be segmented based on any suitable criteria including, but not limited to, function performed by various portions of the boot sequence, data values obtained by various portions of the boot sequence, expected power consumed by the boot sequence segments, expected time consumed by each of the boot sequence segments, and/or the like. The boot sequence may be segmented by the designated programmer, the OEM, the user, or automatically based on the criteria described. The boot sequence (e.g., each of the boot sequence segments) may be executed by the boot sequence device 135 in a sequential manner. Alternatively, two or more of the boot sequence segments may be executed in parallel when processing capability allows.

By way of illustrating with a non-limiting example, a boot sequence may be segmented into boot sequence segments including 1) power on and boot ROM code execution, 2) bootloader, 3) kernel, 4) initialization process, 5) Zygote/Dalvik, 6) system server, and 7) boot completion. In particular, in the power on and boot ROM code execution segment, the mobile device 100 may load boot instructions onto a RAM and executed them. In the bootloader segment, the processor 110 and the memory 115 may be set up, and configuration parameters may be provided for the kernel segment. In the kernel segment, cache, memory, schedules, and drivers may be loaded and set up. In the initialization process, a root process (e.g., directories and “init” scripts) may be executed. In the Zygote/Dalvik segment, core library classes may be initialized. In the system server segment, system servers may be initialized to provide system services. Lastly, in the boot completion segment, a completion indicator file may be executed to signal the completion of the booting process.

Next at block B220, each boot sequence segment may be monitored for power consumption and/or time consumption. In various embodiments, the power consumption monitor 125 may be configured to monitor the battery power consumption associated with each boot sequence segment. The mobile device 100 may include (in addition to or as an alternative to the power consumption monitor 125) a time consumption monitor 127 configured for monitoring the time consumption associated with each boot sequence segment.

The power consumption and/or the time consumption associated with each boot sequence segment may be sampled with a predetermined frequency (e.g., every time, every other time, once every 10 times, and/or the like) the mobile device 100 is booted up (a boot instance). In some embodiments, the power and/or time consumption may be monitored for at least one boot instance in the normal mode (e.g., when all features and functions of the mobile device 100 is initialized during the boot sequence). In additional or alternative embodiments, the power and/or time consumption may be monitored for the at least one boot instance in modes other than the normal mode (e.g., the emergency mode, the voice-only mode, the text-only mode, the data-only mode, the location-only mode, and/or the like). The mode in which the mobile device 100 is booted up in and/or the associated boot sequence segment may be determined and stored with the data values representing the power and/or time consumption. The data value representing the power and/or time consumption, the associated mode, and the associated boot sequence segment may be stored together in the memory 115, the memory of the power consumption monitor 125, the memory of the time consumption monitor 127, an external memory device, cloud storage, and/or the like.

Next at block B230, at least one power-hungry boot sequence segment may be determined. In addition or in the alternative, at least one time-consuming boot sequence segment may be determined. In some embodiments, the power-hungry boot sequence segment and/or the time-consuming boot sequence segment may be determined based at least in part on the data values (representing the battery power and/or time consumed) stored with respect to each of the boot sequence segments.

For example, a weighted average of the battery power consumed may be computed with respect to each boot sequence segment. In further embodiments, the weighted average of battery power consumed may also be computed with respect to each boot mode in addition to each boot sequence segment. In some embodiments, at least one boot sequence segment having the most weighted average of battery power consumption may be determined to be the power-hungry segment(s). In other embodiments, boot sequence segment(s) having weighted average of battery power consumption exceeding a predetermined threshold level may be determined to be the power-hungry segment(s).

In alternative or additional examples, a weighted average of the time consumed may be computed with respect to each boot sequence segment. In further embodiments, the weighted average of time consumed may also be computed with respect to each boot mode in addition to each boot sequence segment. In some embodiments, at least one boot sequence segment having the most weighted average of time consumption may be determined to be the time-consuming segment(s). In other embodiments, boot sequence segment(s) having weighted average of time consumption exceeding a predetermined threshold level may be determined to be the time-consuming segment(s).

Although power and/or time consumption statistics related to each segment of the boot sequence may be obtainable from the original equipment manufacturer (OEM), such statistics may not be accurate. This may be because mobile devices (e.g., the mobile device 100) of a same model may be subject to different environmental factors such as heat, component degradation, different boot up (or set up) routines, previous use, and/or the like. In addition, mobile devices having different programs or applications installed may experience different power/time consumption at a same segment of the boot sequence. Accordingly, by monitoring and sampling the power/time consumption associated with each boot sequence segment (and/or each boot up mode), individualized and pertinent data may be obtained with respect to that particular mobile device 100.

Also, as an average user of the mobile device 100 may be inclined to not shut off the mobile device 100 often (given that the average user may simply leave the mobile device 100 on unless the battery may be critical), a crowd-sourcing solution may be available. That is, instead of sampling the power/time consumption associated with various boot sequence segments of a same mobile device (e.g., the mobile device 100), additional mobile devices (such as, but not limited to the mobile device 100) may be sampled. The additional mobile devices may be sampled in a manner similar to described with respect to the mobile device 100. Sampled data values may be stored at a server (e.g., a cloud server) accessible by all mobile devices. Next, a weight average of power/time consumption may be computed based on the data values associated with the mobile device 100 as well as the additional mobile devices.

It should be appreciated by one of ordinary skill in the art that other ways of determining the power-hungry segment(s) and the time-consuming segment(s) based on sampled and stored values may be implemented without deviating from the spirit of the disclosure.

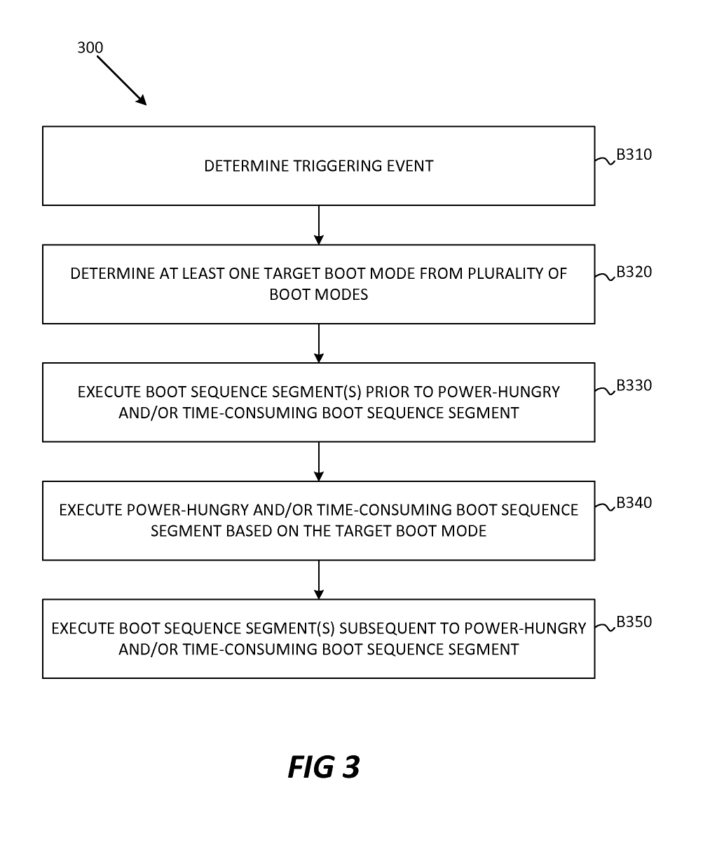

A process flowchart of a modified boot sequence process 300 is illustrated in FIG. 3 according to various embodiments. With reference to FIGS. 1-3, first at block B310, a triggering event may be determined (e.g., by the triggering event detector 140). In some embodiments, the triggering event detector 140 may detect the battery power level of the mobile device 100 reaching a predetermined battery level (e.g., 15%, 10%, 5%, 2%, 1%, and/or the like). In further or alternative embodiments, the triggering event detector 140 may signal a detected triggering event when the triggering event detector 140 detects a battery power level drain exceeding a predetermined threshold (e.g., 1% per 5 minutes, 1% per 1 minute, and/or the like). In still further or alternative embodiments, the triggering event detector 140 may detect a user input. For example, the triggering event detector 140 may be coupled to the user interface 120. The user interface 120 may receive a user input indicating that the user may wish to trigger the modified boot sequence (e.g., trigger the rest of the modified boot sequence process 300).

In various embodiments, determination of the triggering event may take place while the mobile device 100 is operating in the normal mode (e.g., the mobile device 100 has been booted up in the normal mode and is operating with its full features/functions). For example, while the mobile device 100 is operating in its normal mode, the triggering event is detected when the battery power level reaches a predetermined threshold. In another example, while the mobile device 100 is operating in its normal mode, the triggering event is detected when the user of the mobile device 100 indicates (e.g., through the user interface 120 and the triggering event detector 140) that the modified boot sequence may be desired. In these situations, the mobile device 100 may be configured to power off in response to the triggering event detected.

In other embodiments, the determination of the triggering event may take place when the mobile device 100 is being powered on after being powered off. In other words, the determination of the triggering event may take place after the mobile device has been powered off and powered on again. For example, the mobile device 100 may be powered off due to the user powering off the mobile device 100 because the user desires to conserve remaining battery power, the mobile device 100 automatically powering off due to low battery power level, and/or the like. Immediately following powering on and before the remaining steps of the modified boot sequence process 300, the determination of the triggering event may take place.

Next at block B320, the mode selector 130 may determine at least one target boot mode from a plurality of boot modes. In various embodiments, the mode selector 130 (including or coupled to the user interface 120) may accept user input indicating at least one target boot mode. For example, the plurality of boot modes may be displayed to the user via the user interface 120. The user may select one or more of the target boot mode in the manner described. In some embodiments, the user may be able to select two or more boot modes as the target boot modes.

In other embodiments, the mode selector 130 may select one or more of the plurality of boot modes automatically without user input. In some embodiments, the mode selector 130 may determine the function(s)/feature(s) actively used by the user of the mobile device 100 before the triggering event is detected. For example, where the user was using a telephonic call feature before the triggering event is detected, the target boot mode may be a voice-only mode. In another example, the mode selector 130 may determine that the user was using a short message service (SMS) and a map application within a predetermined period of time (e.g., 3 minutes, 1 minute, 30 seconds, 10 seconds, and/or the like) before the triggering event is detected. Then, the mode selector 130 may select text-only mode and the location-only mode as the target boot modes.

In still another example, the mode selector 130 may determine that the emergency mode is desired when the triggering event is the battery power level dropping below a predetermined threshold and the location associated with the mobile device 100 is determined to be associated with a “dangerous area” (e.g., in a wooded area, in a largely unoccupied area, and/or the like).

Next at block B330, boot sequence segment(s) prior to the power-hungry and/or the time-consuming segment(s) may be executed (e.g., by the boot sequence device 135), unless the power-hungry and/or the time-consuming segment(s) is the first boot sequence segment(s). The power-hungry and/or the time-consuming segment(s) may be determined such as, but not limited to, as described with respect to blocks B210-B230 of the power-hungry and/or time-consuming boot sequence segment determination process 200. The boot sequence segment(s) prior to the power-hungry and/or the time-consuming segment(s) as determined by the process 200 may be executed in the normal mode. That is, the boot sequence device 135 may execute the prior boot sequence segment(s) for complete functions/features enabled by the mobile device 100. In other words, all hardware/software resources may be initialized to the extent of the operations prescribed in the prior boot sequence segment(s).

Next at block B340, the boot sequence device 135 may execute the power-hungry and/or time-consuming segment(s) based at least in part on the target boot mode(s). As described, all boot modes other than the normal mode may enable set up, configuration, or initialization of some hardware/software resources of the mobile device but not others. Thus, only the hardware/software resources corresponding to the particular target boot mode(s) may be configured in the power-hungry and/or time consuming segment(s).

For example, whereas the target boot mode is the data-only mode, only modem, Wi-Fi resources/drivers, and/or the like (as well as applications that require data) may be configured in the power-hungry and/or time-consuming segments. In another example, whereas the text-only mode and the location-only mode are the target boot modes, the modem, vocoder resources/drivers, Wi-Fi resources/drivers, geo-location system, and/or the like (as well as the corresponding applications related to texting and geo-positioning) may be configured in the power-hungry and/or time-consuming segments.

Next at block B350, boot sequence segment(s) subsequent to the power-hungry and/or the time-consuming segment(s) may be executed (e.g., by the boot sequence device 135). This may occur when the power-hungry and/or the time-consuming segment(s) is not the last boot sequence segment(s). Otherwise, the modified boot sequence is completed without block B350. The boot sequence segment(s) subsequent to the power-hungry and/or the time-consuming segment(s) as determined by the process 200 may be executed in the normal mode. That is, the boot sequence device 135 may execute the subsequent boot sequence segment(s) for complete functions/features enabled by the mobile device 100. In other words, all hardware/software resources may be initialized in the subsequent boot sequence segment(s) to the extent of the operations prescribed in the subsequent boot sequence segment(s).

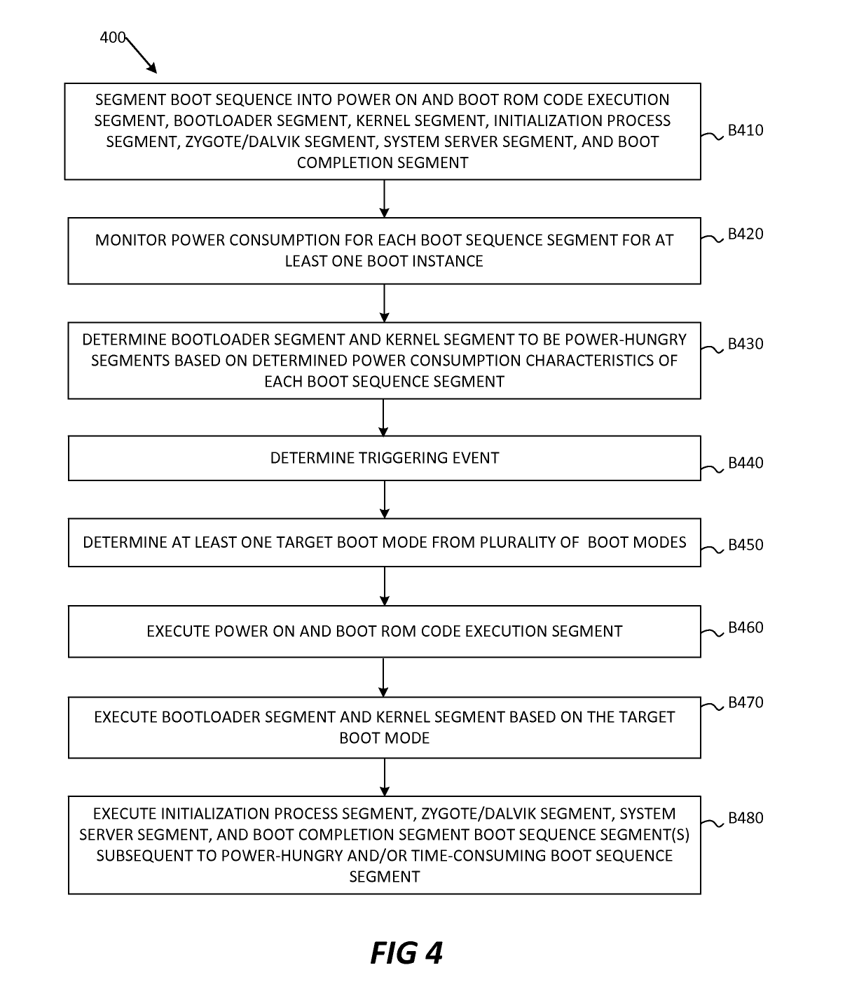

A process flowchart of an example process 400 is illustrated in FIG. 4 according to various embodiments. The example process 400 may be particular implementations of the boot sequence segment determination process 200 and the modified boot sequence process 300. With reference to FIGS. 1-4, first at block B410, an example boot sequence may be segmented into boot sequence segments such as, but not limited to, a power on and boot ROM code execution segment, bootloader segment, kernel segment, initialization process segment, Zygote/Dalvik segment, system server segment, and boot completion segment. Such segmentation of the boot sequence segment is based on distinctive operations performed during the boot sequence.

Next at block B420, the power consumption monitor 125 may monitor the power consumption of each of the power on and boot ROM code execution segment, bootloader segment, kernel segment, initialization process segment, Zygote/Dalvik segment, system server segment, and boot completion segment. The power consumption monitor 125 may determine the power consumed by each of the boot segments during at least one boot instance in the manner such as, but not limited to, as described with respect to block B220.

Next at block B430, the power consumption monitor 125 may determine the bootloader segment and the kernel segment to be the power-hungry segments based on determined power consumption characteristics of each of the boot sequence segments defined with respect to block B410. In particular embodiments, the power consumption of each of the boot sequence segments may be determined for multiple boot instances (multiple times that the mobile device 100 is booted up). An average power consumption is computed for each boot sequence segment. The two boot sequence segments (e.g., the bootloader segment and the kernel segment) that consume the most power on average may be selected as the power-hungry segment. In practice, it may often be the case that the bootloader segment and/or the kernel segment may be the most power-hungry segments as determined by the process described herein. However, it should be appreciated by one of ordinary skill in the art that additional or alternative boot sequence segment(s) may be determined to be a power-hungry segment(s) given that power consumption (as well as time consumption) may be based on changing environmental factors.

Next at block B440, a triggering event may be detected by the triggering event detector 140 in a manner such as, but not limited to, as described with respect to block B310. Then at block B450, the mode selector 130 may determine at least one target boot mode from a plurality of boot modes in a manner such as, but not limited to, as described with respect to block B320. In particular embodiments, the target boot mode may be one of the emergency mode, mobile-voice-only mode, text-only mode, data-only mode, location-only mode, normal mode, and/or the like.

Next at block B460, the mobile device 100 (e.g., the boot sequence device 135) may execute the power on and boot ROM code execution segment. In particular, the power on and boot ROM code execution segment may be executed in the normal mode. That is, the boot sequence device 135 may execute the power on and boot ROM code execution segment for complete functions/features enabled by the mobile device 100. In other words, all hardware/software resources may be initialized to the extent of the operations prescribed in the power on and boot ROM code execution segment.

Next at block B470, the mobile device 100 (e.g., the boot sequence device 135) may execute the bootloader segment and kernel segment based on the target mode. In some embodiments, the bootloader segment may be executed in response to the completion of the power on and boot ROM code execution segment. The kernel segment may be executed sequentially to the execution of the bootloader segment. As described, only the hardware/software resources corresponding to the particular target boot mode(s) may be configured in the bootloader segment and kernel segment.

For example, whereas the target boot mode is the data-only mode, the bootloader and the kernel should only initialize modem, Wi-Fi resources/drivers, and/or the like related to data services and/or data applications. In another example, whereas the target boot mode is the emergency mode, the bootloader and the kernel should only initialize the modem, vocoder resources/drivers, Wi-Fi resources/drivers, geo-location system, and/or the like related to telephony services, emergency dialer, SOS, location-based application, and/or the like.

Next at block B480, the initialization process segment, zygote/dalvik segment, system server segment, and boot completion segment may be executed (e.g., by the boot sequence device 135). The initialization process segment, zygote/dalvik segment, system server segment, and boot completion segment may be executed in the normal mode. That is, the boot sequence device 135 may execute these boot sequence segments for complete functions/features enabled by the mobile device 100. In other words, all hardware/software resources may be initialized in the subsequent boot sequence segment(s) to the extent of the operations prescribed in the prior boot sequence segment(s).

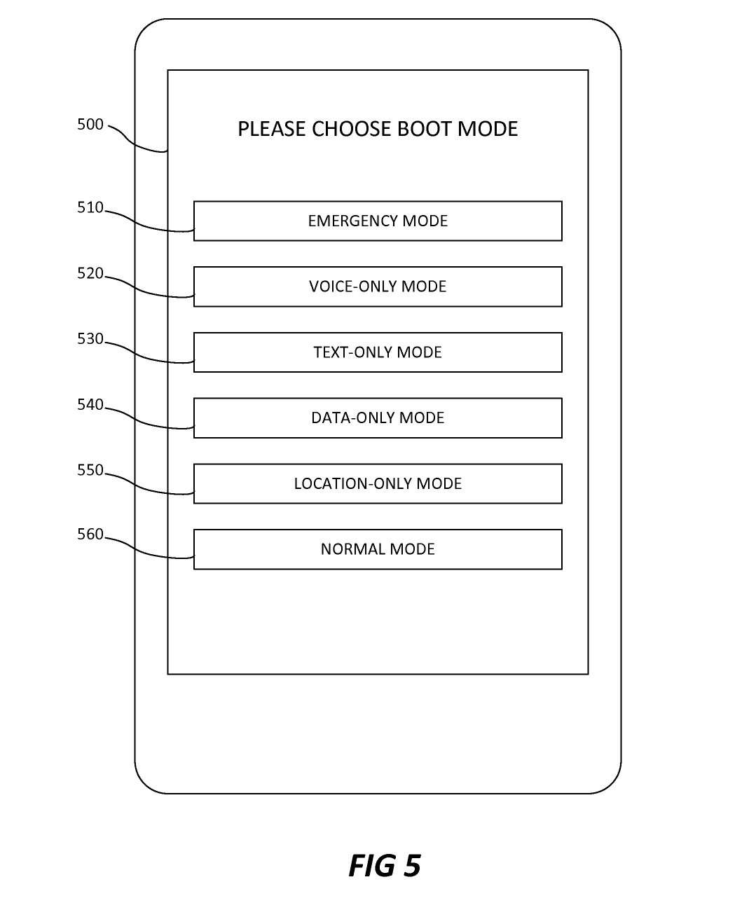

FIG. 5 illustrates an example of a mode selection screen 500 suitable for implementation for various embodiments. In some embodiments, the mode selection screen 500 may be presented to the user (e.g., via the user interface 120) in response to a triggering event (e.g., as determined in block B310 or B440) being detected. The mode selection screen 500 is a method by which the user of the mobile device 100 may select the target boot mode from the plurality of available boot modes (e.g., as described with respect to block B320 or B450). In various embodiments, the mode selection screen 500 may be displayed with a rudimentary GUI. As described, the rudimentary GUI may be a GUI having a least amount of graphical and/or audio tasks, thus reducing power consumption and minimizing runtime.

In some embodiments, the mode selection screen 500 may be displayed by the user interface 120 during the normal operations of the mobile device (i.e., before the boot sequence is initiated). Specifically, the mode selection screen 500 may be displayed when the mobile device 100 detects a triggering event during normal operations (i.e., before the mobile device 100 is powered off and rebooted for mode-specific configurations). Thus, according to those embodiments, the target boot mode may be selected before the mobile device 100 is powered off and rebooted in the target boot mode. In other embodiments, the mode selection screen 500 may be displayed after the mobile device 100 has been rebooted (i.e., powered on for mode-specific boot sequence) but before the boot sequence occurs.

The mode selections screen 500 may include various mode-specific interactive elements. When selected by the user of the mobile device 100 through the user interface 120, the mode associated with the selected mode-specific interactive element may be set as the target boot mode. In some embodiments, the mode-specific interactive elements may include an emergency mode element 510, a voice-only mode element 520, a text-only mode element 530, a data-only mode element 540, a location-only mode element 550, a normal mode element 560, and/or the like. The emergency mode element 510 may be associated with the emergency mode. The voice-only mode element 520 may be associated with the voice-only mode. The text-only mode element 530 may be associated with the text-only mode. The data-only mode element 540 may be associated with the data-only mode. The location-only mode element 550 may be associated with the location-only mode. The normal mode element 560 may be associated with the normal mode.

It should be appreciated by one of ordinary skills in the art that two or more of the mode-specific interactive elements may be selected. In such cases, the mobile device 100 may enable initialization or boot up based on the modes associated with each of the mode-specific interactive elements.

In response to the selection being made as to the target boot mode, the mobile device 100 may then be configured to be booted up based at least in part on the target boot mode selected.

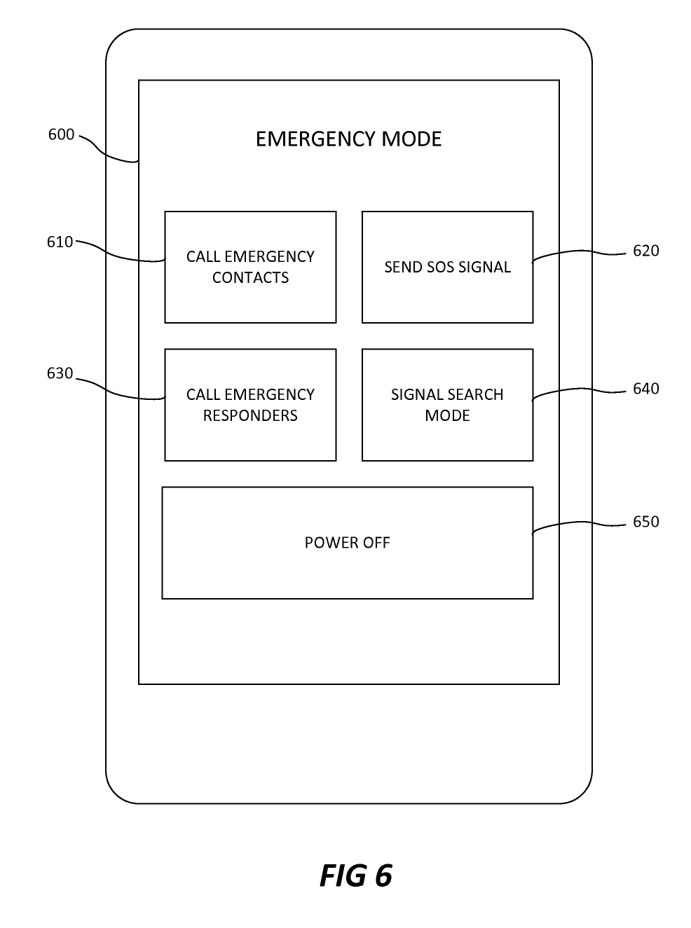

FIG. 6 illustrates an example of an emergency mode home screen 600 suitable for implementation for various embodiments. In some embodiments, the emergency mode home screen 600 may be presented to the user (e.g., via the user interface 120) when the mobile device 100 has been rebooted based on the target boot mode(s) selected (e.g., in response to the completion of block B350 and B480). The emergency mode home screen 600 may be associated with the target boot mode being the emergency mode. The emergency mode home screen 600 may be displayed to the user of the mobile device 100 through the user interface 120.

The emergency mode home screen 600 may include an emergency contact calling feature associated with an emergency contacts element 610. When the emergency contacts element 610 is selected by the user through the user interface 120, the user interface 120 may display at least one emergency contact information (e.g., including name, phone number, email, and/or the like). An emergency contact list (e.g., which may be a subset of the contact list stored within the mobile device at the memory 115) may be initiated during the modified boot sequence (e.g., as instructed based on the instructions of the emergency mode) to enable such functionality. Features such as voice call, SMS, email, and/or the like may be implemented for the emergency mode.

The emergency mode home screen 600 may also include an SOS signal transmission element 620. When the SOS signal transmission element 620 is selected by the user through the user interface 120, the mobile device 100 may automatically transmit a distress signal, SOS signal, and/or the like over any suitable wireless network. Accordingly, wireless network devices (e.g., the modem, various wireless resources, and/or the like) may be initialized for the emergency mode. In further embodiments, data related to the location of the mobile device 100 may be sent together with the distress signal. Thus, a geo-location device may be initiated additionally when booting up in the emergency mode.

The emergency mode home screen 600 may also include an emergency responder element 630. When activated through the user interface 120 by the user, the mobile device 100 may automatically call a predetermined emergency responder (e.g., “911” and/or telephonic contact numbers of a designated emergency responder).

The emergency mode home screen 600 may also include a signal search element 640. When activated, the mobile device 100 may enter a signal search mode. The signal search mode may be characterized as a minimal power consumption mode that the mobile device 100 enters when no wireless network may be available to send messages or make calls. In the signal search mode, the mobile device 100 halts displaying or any applications that may be executed at the moment in response to not being able to detect wireless service/signals within a predetermined period of time (e.g., 10 seconds, 30 seconds, 1 minute, and/or the like). The mobile device 100 may automatically exit out of the signal search mode within a predetermined period of time (e.g., 30 seconds, 34 seconds, 2 minutes, and/or the like). One of ordinary skill in the art would appreciate that the signal search element 640 and/or the signal search mode as described may also be implemented for home screens associated with other boot modes.

A power-off element 650 may be included in the emergency mode home screen 600. When activated, the power-off element 650 may cause the mobile device 100 to be powered off.

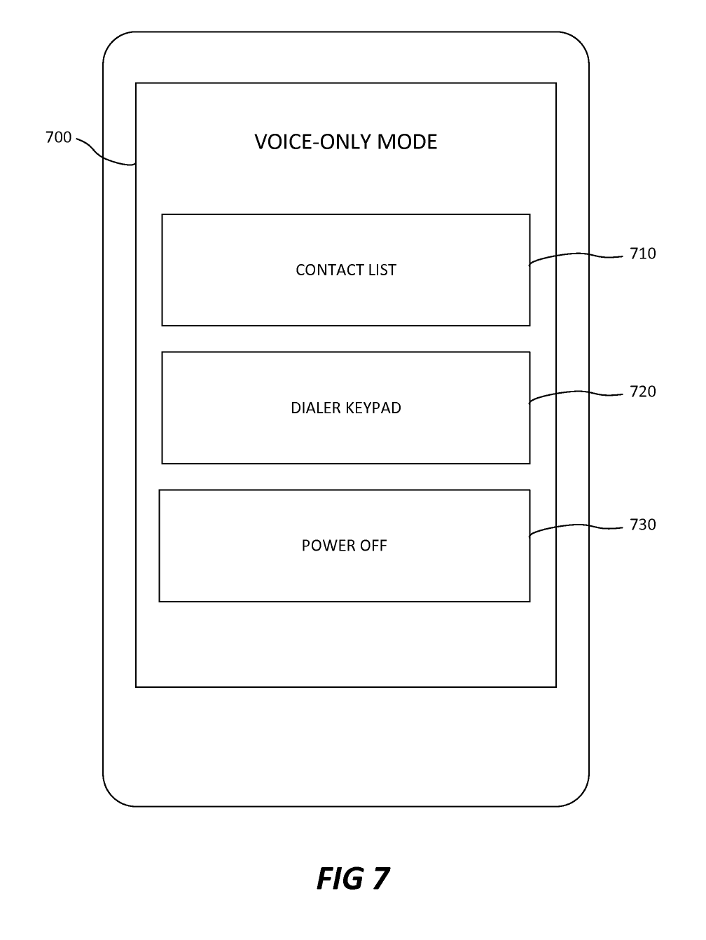

FIG. 7 illustrates an example of an voice-only mode home screen 700 suitable for implementation for various embodiments. In some embodiments, the voice-only mode home screen 700 may be presented to the user (e.g., via the user interface 120) when the mobile device 100 has been rebooted based on the target boot mode(s) selected (e.g., in response to the completion of block B350 and B480). The voice-only mode home screen 700 may be associated with the target boot mode being the voice-only mode. The voice-only mode home screen 700 may be displayed to the user of the mobile device 100 through the user interface 120.

The voice-only mode home screen 700 may include a contact list element 710, which may be configured as a user-interactive element. When the user selects the contact list element 710, the user interface 120 may be configured to display at least one contact information (e.g., including name, telephone number, and/or the like). A touch-to-call feature may be enabled. The at least one contact information may be stored on the memory 115 and initialized as a part of the voice-only mode during boot up.

In addition, a dialer element 720 may enable the user interface 120 to display and enable a dialer keypad when selected by the user. Numbers from 0-9 as well as any symbols (e.g., “*,” “#,” and/or the like) may be provided for the dialer keypad. The user may then be able to make a telephonic call to a telephone number. Also, the voice-only mode home screen 700 may include a power-off element 730 such as, but not limited to, the power-off element 650.

One of ordinary skills in the art would appreciate that a home screen for the text-only mode may be implemented in a similar fashion as described with respect to the home screen for the voice-only mode.

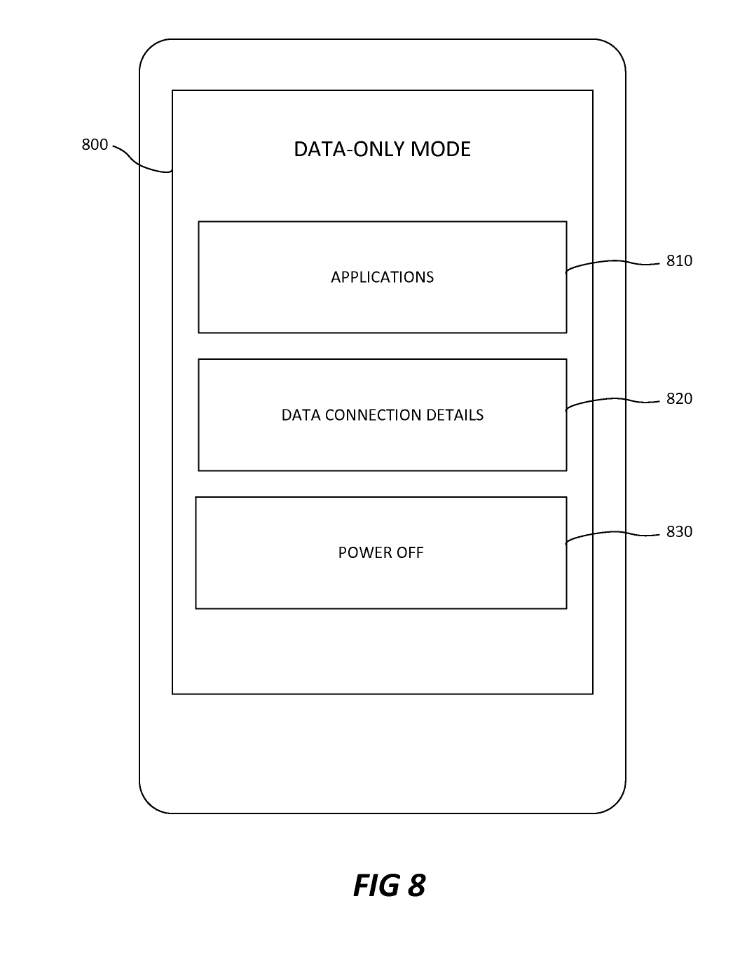

FIG. 8 illustrates an example of an data-only mode home screen 800 suitable for implementation for various embodiments. In some embodiments, the data-only mode home screen 800 may be presented to the user (e.g., via the user interface 120) when the mobile device 100 has been rebooted based on the target boot mode(s) selected (e.g., in response to the completion of block B350 and B480). The data-only mode home screen 800 may be associated with the target boot mode being the data-only mode. The data-only mode home screen 800 may be displayed to the user of the mobile device 100 through the user interface 120.

The data-only mode home screen 800 may include an application element 810, which may be configured as a user-interactive element. When the user selects the application element 810, the user interface 120 may be configured to display at least one application which may depend on the availability of data (e.g., including web browser applications, map applications, games, information applications, applications requiring download/upload links, and/or the like).

In addition, a connection details element 820 may enable the user interface 120 as a user-interactive element. When selected, the details related to data connection may be displayed through the user interface 120 to the user. Such details may include type of network camped on, the availability of Wi-Fi, network speed, and/or the like. In various embodiments the connection details element 820 and the corresponding feature may not be provided, given that it may cause extra power drain. Also, the data-only mode home screen 800 may include a power-off element 830 such as, but not limited to, the power-off element 650.

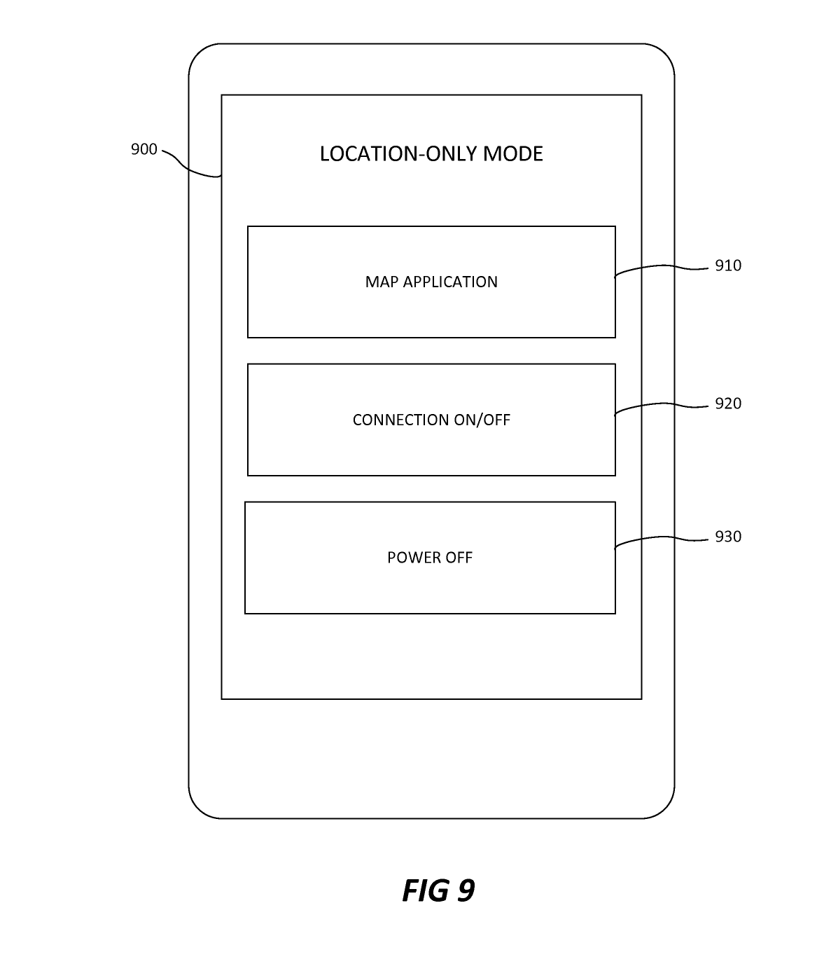

FIG. 9 illustrates an example of a location-only mode home screen 900 suitable for implementation for various embodiments. In some embodiments, the location-only mode home screen 900 may be presented to the user (e.g., via the user interface 120) when the mobile device 100 has been rebooted based on the target boot mode(s) selected (e.g., in response to the completion of block B350 and B480). The location-only mode home screen 900 may be associated with the target boot mode being the location-only mode. The location-only mode home screen 900 may be displayed to the user of the mobile device 100 through the user interface 120.

The location-only mode home screen 900 may include a map application element 910, which may be configured as a user-interactive element. When the user selects the map application element 910, the user interface 120 may be configured to display at least one map application which may depend on the availability of data. The user may select user-interactive elements associated with the at least one map application to interact with the map application(s).

In addition, a connection status element 920 may enable the user interface 120 as a user-interactive element. When selected, the user may choose to whether to enable real-time positioning of the user's location or to disable data connection and assess the map without real-time positioning feature enabled. Also, the location-only mode home screen 900 may include a power-off element 930 such as, but not limited to, the power-off element 650.

Lastly, in a normal mode, the mobile device 100 may be initiated or booted up based on its existing boot up procedures, e.g., the power-hungry and/or time consuming segments may initialize all resources/drivers corresponding to all features of the mobile device 100. All modes described except the normal mode should initiate a subset of hardware/software available.

In various embodiments, the power and/or time consumption of initializing each specific resource may be monitored by the power consumption monitor 125 and the time consumption monitor 127. In particular, with respect to each boot sequence segment, the power consumption monitor 125 and/or the time consumption monitor 127 may determine the power/time consumed to initialize each particular drivers, application, and/or the like. For example, during the bootloader segment and/or the kernel segment, the power/time consumption characteristics may be monitored for initializing each driver (e.g., for loading and executing modem drivers, audio drivers, video drivers, Wi-Fi drivers, universal serial bus (USB) drivers, a combination thereof, and/or the like).

In various embodiments, power numbers may be stored in a memory (e.g., the memory 115, any non-volatile memory, and/or the like). A power number refers to a value representing various types of battery power consumption or battery power consumption estimates. The power numbers may be used in booting up the mobile device 100 in a selected target mode (e.g., the optimal ultra-low power mode) in the manner described. A power number may refer to a boot sequence power demand (BSPD) number, a boot mode power estimate (BMPE) number, and/or the like.

In some embodiments, the BSPD number may be a value indicating the power consumption associated with each boot sequence segment (i.e., the boot sequence may be segmented into a plurality of boot sequence segments such as, but not limited to, illustrated in blocks B210, B410, and/or the like). In other words, after the mobile device 100 monitors the power consumption for each boot sequence segment (e.g., in blocks B220, B420, and/or the like), a value indicating the power consumption associated with each boot sequence segment (e.g., the BSPD number) may be determined and stored. The BSPD number may be determined based on sampled or determined power consumption values associated with each boot sequence segment during at least one boot process (boot instance). The BSPD may be used in the determination of the power-hungry segment(s) in the manner described with respect to blocks B230, B430, and/or the like. In a non-limiting example, the power-hungry segment may be determined to be the kernel segment based on the BSPD numbers. In another non-limiting example, the power-hungry segments may be determined to be the bootloader segment and the kernel segment based on the BSPD numbers.

In addition, the BSPD numbers may be updated and/or refreshed each time the mobile device 100 is booted up. As new values indicating power consumption associated with each boot sequence segment are sampled and stored, the BSPD number may vary each time the mobile device 100 is booted up. This is because calculation of the BSPD number may take into account these new values as well as previous values (and/or previous BSPD numbers).

As implemented in various embodiments, the BMPE number may be a value associated with the overall power consumed during the boot sequence and the operation phase based on a selected target mode. The BMPE numbers may be used as an estimate of the expected battery drainage associated with booting up in a selected target mode (as used in a modified boot sequence) as well as the operations based on the selected mode (e.g., before the mobile device 100 is turned off). The BMPE numbers may also be used to indicate expected battery life when the mobile device 100 is operating under the respective target boot mode (i.e., when the user uses the desired features of the mobile device 100).

The expected battery life may be displayed to the user on the rudimentary GUI (e.g., the user interface 120) when the user is selecting a target mode from a plurality of modes (such as, but not limited to, illustrated in blocks B320, B450, and/or the like). For example, a first BMPE number may indicate an overall power consumed associating with booting up and operating in the emergency mode. In another example, a second BMPE number may indicate an overall power consumed associated with booting up and operating in the text-only mode. Accordingly, the user may be notified of the expected battery power drainage and lifetime when selecting a mode to operate the mobile device 100.

Each time the mobile device 100 is booted up in a modified boot sequence in the manner described, a power consumption value associated with the boot mode may be stored in a memory (e.g., a local database/cache, and/or the like) configured for temporary or expedient storage. In response to the mobile device 100 being switched off, the power consumption value may be read or transmitted to a non-volatile memory for determining the BMPE numbers. Based on the stored power consumption values associated with each boot mode, the mobile device 100 (e.g., the power consumption monitor 125) may determine a BMPE number for each modified boot mode. A database on previous stored power consumption values associated with each available boot mode as well as previous iterations of the BMPE numbers may be accumulated after many boot sequences executed based on various different target boot modes.

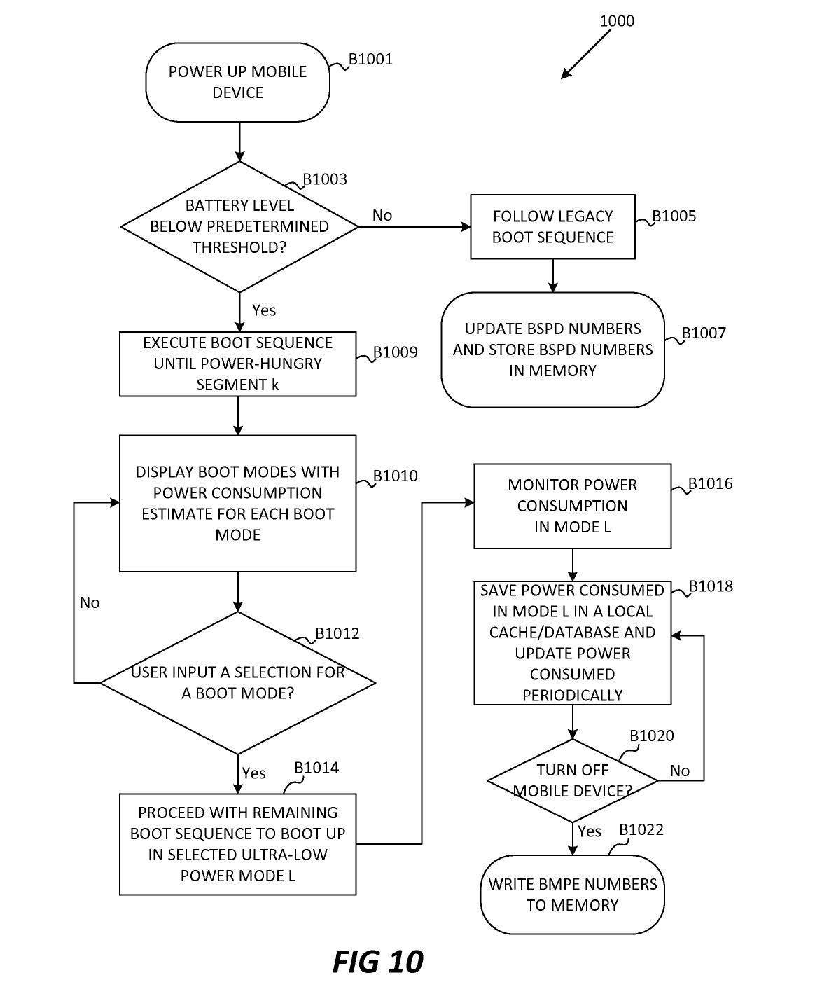

FIG. 10 is a process flowchart of an example of a power-based boot sequence illustrated according to various embodiments. Now referring to FIGS. 1-10, an example power-based boot sequence 1000 is described according to various implementations of the modified boot sequence process, power-hungry boot sequence segment determination process, example process, and/or the like. In particular, the example power-based boot sequence 1000 may relate to or be implementations of the power-hungry and/or time-consuming boot sequence segment determination process 200, the modified boot sequence process 300, the example process 400, and/or the like.

First at block B1001, the mobile device 100 may be powered up. The mobile device 100 may be switched on manually with a user intent to perform at least a function desired by the user of the mobile device 100. Next at block B1003, the mobile device 100 may be configured to determine whether battery level remaining is below a predetermined threshold (with a triggering event detector 140 of the mobile device 100). For example, the triggering event detector 140 may be configured to detect the battery power level of the mobile device 100 and compare it with the predetermined battery power threshold. The battery power threshold may be 15%, 10%, 5%, 2%, and/or 1% of total battery power. Such triggering event detection may include, but not limited to, blocks B310 and B440.

When the battery power level is determined to be above (and/or equal to) the predetermined threshold (B1003:NO), the mobile device 100 may follow a legacy boot sequence at block B1005. In various embodiments, the legacy boot sequence may refer to a default or regular boot sequence of the mobile device 100. All resources (e.g., hardware and software) of the mobile device 100 may be enabled during the legacy boot sequence.

Next at block B1007, the mobile device 100 may update BSPD numbers and store the BSPD numbers in a memory. In various embodiments, the memory may be the memory 115 and/or any non-volatile memory. As described, the BSPD numbers may indicate the power consumption associated with each boot sequence segment. During the legacy boot sequence, the power consumption with respect to each boot sequence may be monitored (e.g., with the power consumption monitor 125 of the mobile device 100). The BSPD number may be determined based on sampled or determined power consumption values as monitored by the power consumption monitor 125 in the manner described. The BSPD may be used in the determination of the power-hungry segment(s) in the manner described at least with respect to blocks B230, B430, and/or the like.

Whereas the battery power level is determined to be below (and/or equal to) the predetermined threshold (B1003:YES), then next at B1009, the mobile device 100 may execute the boot sequence until a power-hungry segment k (such as, but not limited to, as described with respect to blocks B330 and B460) is reached. The power-hungry segment k may be a boot sequence segment selected based on the BSPD numbers in a manner such as, but not limited to, blocks B230 and B430.

Next at block B1010, the mobile device 100 may display (e.g., via the user interface 120) boot modes with power consumption estimate displayed for each boot mode. In some embodiments, the power consumption estimate associated with each boot mode may include the BMPE numbers determined in the manner described. The user may select at least one boot mode to boot the mobile device 100 in. The user may be assisted by the power consumption estimate (the BMPE number) that may indicate to the user estimated power usage and battery lifetime when the associated boot mode is selected.

Next at block B1012, the mobile device 100 may determine whether the user of the mobile device 100 has inputted (e.g., via the user interface 120) a selection for a boot mode. For example, blocks B1010 and B1012 may be implemented in a manner such as, but not limited to, illustrated at least with respect to blocks B320 and B450. Whereas no input has been received (B1012:NO), the mobile device 100 may be configured to remain displaying the boot modes with the power consumption estimate for each boot mode in block B1010.

On the other hand, when the user has inputted a selection (B1012:YES), the mobile device 100 may proceed with the remaining boot sequence to boot up in selected ultra-low power mode L at block B1014. For example, this may occur when the user selects “ultra-low power mode L” as the target boot mode. The mobile device 100 may be booted in a manner such as, but not limited to, blocks B340-B350 and B470-480. For example, the remaining boot sequence may be booted based on the ultra-low power mode L. In another example, some of the remaining boot sequence may be booted based on the ultra-low power mode L while the remainder of the remaining portion of the boot sequence may be booted based on the legacy mode.

Next at block B1016, power consumption in mode L may be monitored (e.g., with the power consumption monitor 127). The power consumption monitor 127 may output a value indicating the overall power consumed during this boot process as well as power consumed while the mobile device 100 is operating in mode L. For example, the power consumption may be monitored from the start of block B1001 to the end of block B1018 (e.g., before the mobile device 100 is turned off). Next at block B1018, the mobile device 100 may store the power consumed by the boot sequence (which is based at least partially on mode L) in a local cache/database and updated periodically. As long as the mobile device 100 is not turned off after it is booted in mode L, the power consumption monitor 127 may be configured to monitor the power consumed. The battery power consumed within a period (e.g., 10 s, 30 s, 1 min, and/or the like) may be updated at the end of the period (e.g., every 10 s, 30 s, 1 min, and/or the like) to the local cache/database.

Next at block B1020, the mobile device 100 may detect whether the mobile device 100 is turned off. As long as the mobile device 100 is not turned off following the boot sequence in mode L (B1020:NO), the process described with respect to block B1018 may be executed. For example, the power consumed during the operational phase in mode L may be monitored continuously. The power consumed may be updated periodically in the manner described.

Whereas the mobile device 100 is turned off (B1020:YES), the mobile device 100 may be configured to write the BMPE number to a memory. The memory may be the memory 115, a non-volatile memory, and/or the like. In some embodiments, in response to the mobile device 100 being switched off, an intermediate BMPE number (e.g., a value indicating boot mode power consumption with respect to this particular boot sequence and operating phase) may be determined (e.g., through computing a weighted average of the values indicating power consumed in mode L during boot up and operations, as well as other suitable manners). The intermediate BMPE number may be stored to the non-volatile memory to compute the BMPE number, which may be used as a power consumption estimate at block B1010 for a subsequence boot sequence. In other embodiments, the individual sampled power consumption values may be transmitted to the non-volatile memory. The BMPE number associated with the mode (e.g., mode L) may be calculated based on the sampled power consumption values. The content stored on the local memory storage may be deleted when desired data are transmitted to the non-volatile memory.

Based on the power/time consumption characteristics for each driver with respect to each boot sequence segment, an optimal set of hardware resources (as well as the software applications corresponding to the set of hardware resources) may be determined. In some embodiments, hardware resources (and the corresponding software applications) may not be initialized (e.g., not a part of the normal mode, voice-only mode text-only mode, data-only mode, location-only mode, and/or the like) when the power/time consumption exceed a predetermined threshold. For example, for the voice-only mode, when initializing the Wi-Fi resources is determined to be time-consuming (e.g., exceeding 2 seconds, 3 seconds, or 4 seconds load time), then the Wi-Fi resources may not be initialized as a part of the voice-only mode.

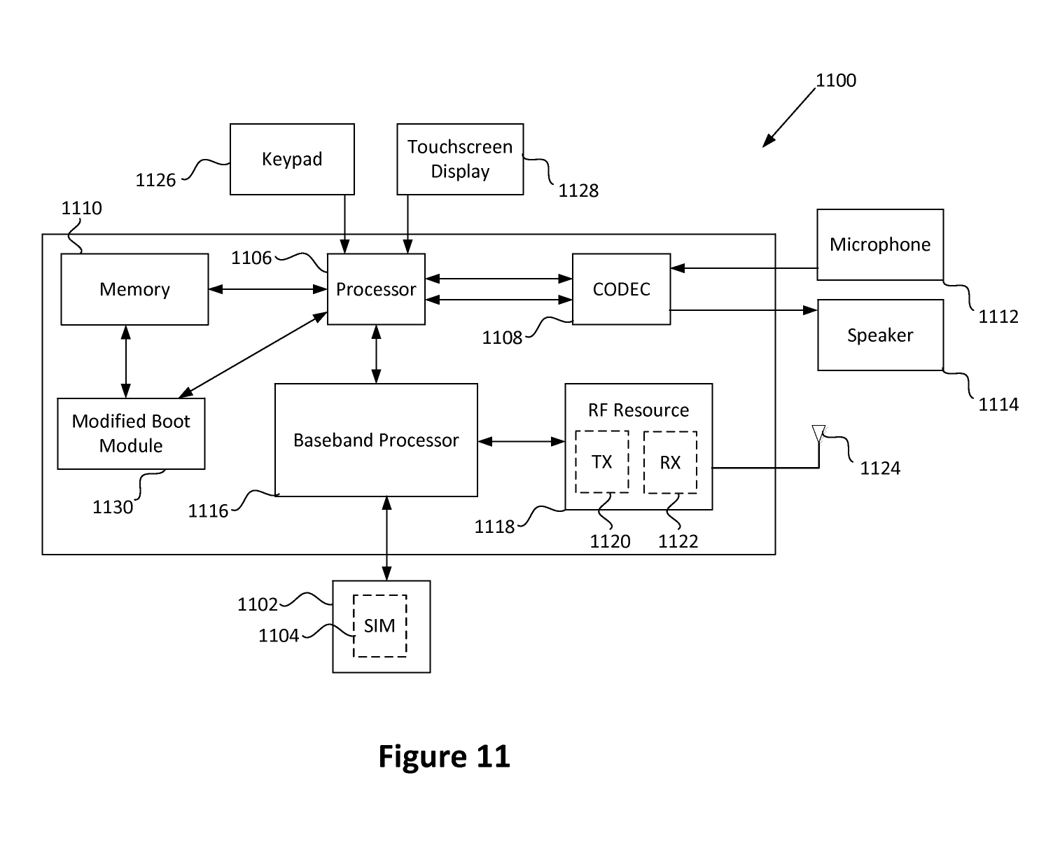

FIG. 11 is a functional block diagram of a mobile device 1100 according to various embodiments of the disclosure. Referring to FIGS. 1-11, the mobile device 1100 may be used as a mobile device implementing the mobile device bootup system 100 as described previously herein.

Mobile device 1100 may include an identity module interface 1102. Identity module interface 1102 may receive an identity module 1104 associated with a subscription for a user of mobile device 1100. In some embodiments, identity module interface 1102 may be a SIM interface and identity module 1104 may be a SIM card.

Mobile device 1100 may include at least one processor 1106. In some embodiments, processor 1106 may be provided as a general purpose processor. Processor 1106 may include any suitable data processing device, such as a general purpose processor (e.g., a microprocessor). In the alternative, processor 1106 may be any suitable electronic processor, controller, microcontroller, or state machine. Processor 1106 may also be implemented as a combination of computing devices, e.g., a combination of a DSP and a microprocessor, a plurality of microprocessors, at least one microprocessor in conjunction with a DSP core, or any other such configuration.

Mobile device 1100 may include a coder/decoder (CODEC) 1108 coupled to processor 1106. CODEC 1108 may in turn be coupled to one or more user interface devices. The user interface device may include a display and a user input device. In various embodiments, the display may include any suitable device that provides a human-perceptible visible signal, audible signal, tactile signal, or any combination thereof. The display may include, but is not limited to, a touchscreen, LCD, LED, CRT, plasma, other suitable display screen, audio speaker 1114, other audio generating device, combinations of the preceding, and the like. In various embodiments, the user input device may include any suitable device that receives input from the user. The user input device may include, but is not limited to, one or more manual operators (such as, but not limited to a switch, button, touchscreen, knob, slider, or the like), microphone 1112, camera, image sensor, combinations of the preceding, and the like.

Mobile device 1100 may include at least one memory 1110 coupled to processor 1106. Memory 1110 may be a non-transitory processor-readable storage medium that stores processor-executable instructions. This medium may include, but is not limited to, random access memory (“RAM”), read only memory (“ROM”), floppy disks, hard disks, dongles, USB connected memory devices, combinations of the preceding, or the like. Memory 1110 may store an operating system (“OS”) as well as user application software and executable instructions.

Mobile device 1110 may include at least one baseband processor 1116 coupled to processor 1106. Baseband processor 1116 may be a baseband modem processor. Each identity module in mobile device 1100 (e.g., identity module 1104) may be associated with baseband-RF resources. The RF resources may include at least one baseband-RF resource chain. The baseband-RF resource chain may include baseband processor 1116, which may perform baseband/modem functions for communications on identity module 1104. The baseband-RF resource chain may also include one or more amplifiers and radios, such as RF resource 1118. RF resource 1118 may be a transceiver that performs transmit/receive functions for mobile device 1100. RF resource 1118 may include transmitter 1120 and receiver 1122. RF resource 1118 may include separate transmit and receive circuitry, or it may include a transceiver that combines transmitter and receiver circuitry. RF resource 1118 may be coupled to a wireless antenna 1124 for transmitting and receiving wireless signals across a wireless medium. RF resource 1118 may further be coupled to baseband processor 1116.

In some embodiments, processor 1106, memory 1110, baseband processor 1116, and RF resource 1118 may be included in mobile device 1100 as a system-on-chip. In some embodiments, identity module 1104 and identity module interface 1102 may be external to the system-on-chip. Further, various input and output devices may be coupled to components on the system-on-chip, such as interfaces or controllers. Example user input components suitable for use in mobile device 1100 may include, but are not limited to, a keypad 1126, touchscreen display 1128, and microphone 1112.

In some embodiments, keypad 1126, touchscreen display 1128, microphone 1112, or a combination thereof may receive a request to initiate an outgoing call. For example, touchscreen display 1128 may receive a selection of a contact from a contact list or receive a telephone number. As another example, the request to initiate the outgoing call may be in the form of a voice command received via microphone 1112. Interfaces may be provided between the various software modules and functions in mobile device 1100 to enable communication between them, as is known in the art.

In some embodiments (not shown), mobile device 1100 may include, among other things, additional identity modules (e.g., additional SIM cards), additional identity module interfaces (e.g., additional SIM interfaces), a plurality of RF resources, and additional antennae for connecting to additional mobile networks.

In particular embodiments, memory 1110 may be configured to store processor-executable instructions for performing various features related to the present disclosure, such as stored in the memory 115.

The mobile device 1100 may be the mobile device 100. In various embodiments, the processor 1106 may be the processor 110. The memory 1110 may be the memory 115. The user interface 120 may include the keypad 1126, the touchscreen display 1128, the microphone 1112, the speaker 1114, and the like. In addition, a modified boot module 1130 may be coupled to the memory 1110 and the processor 1106. The modified boot module 1130 may store instructions for the power consumption monitor 125, the time consumption monitor 127, the mode selector 130, the boot sequence device 135, and the triggering event detector 140 within an internal memory of the modified boot module or in the memory 1110 to which the modified boot module is coupled. Processes and features of the power consumption monitor 125, the time consumption monitor 127, the mode selector 130, the boot sequence device 135, and the triggering event detector 140 may be executed by an internal processor of the modified boot module 1130 and/or the processor 1106 to which the modified boot module 1130 may be coupled.

Instructions for the emergency-mode resources 145, the voice-only mode resources 150, the text-only mode resources 155, the data-only mode resources 160, the location-only mode resources 170, and the normal mode resources 175 may be stored within an internal memory of the modified boot module 1130 or the memory 1110. Hardware resources of the emergency-mode resources 145, the voice-only mode resources 150, the text-only mode resources 155, the data-only mode resources 160, the location-only mode resources 170, and the normal mode resources 175 may include the keypad 1126, touchscreen display 1128, microphone 1112, speaker 1114, CODEC 1108, baseband processor 1116, RF resource 1118, wireless antenna 1124, identity module interface 1102, and/or the like.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for booting up a mobile device, the method comprising:
segmenting a boot sequence of the mobile device into a plurality of boot sequence segments;
determining a first boot sequence segment from the plurality of boot sequence segments, wherein a battery power consumption of the first boot sequence segment exceeds a threshold;
selecting a target boot mode from a plurality of boot modes, wherein each of the plurality of boot modes enables at least some but not all resources of the mobile device;
executing the first boot sequence segment when the target boot mode is implemented; and
executing at least one of the plurality of boot sequence segments other than the first boot sequence segment when a normal mode is implemented, wherein the normal mode enables all resources of the mobile device.

2. The method of claim 1, wherein the segmenting the boot sequence comprises:
monitoring, for each of the plurality of boot sequence segments, battery power consumption associated with at least one boot instance;
determining, for each of the plurality of boot sequence segments, battery power consumption characteristics based on the battery power consumption associated with the at least one boot instance; and
determining the first boot sequence segment based, at least in part, on the battery power consumption characteristics.

3. The method of claim 1, further comprising:
determining a second boot sequence segment from the plurality of boot sequence segments, time consumed by the second boot sequence exceeds a predetermined temporal threshold; and
executing the second boot sequence segment based on the target boot mode.

4. The method of claim 3, wherein the segmenting the boot sequence comprises:
monitoring, for each of the plurality of boot sequence segments, time consumption associated with two or more boot instances;
determining, for each of the plurality of boot sequence segments, time consumption characteristics based on the time consumption associated with the two or more boot instances; and
determining the second boot sequence segment based, at least in part, on the time consumption characteristics.

5. The method of claim 1, further comprising determining a triggering event, wherein the target boot mode is selected in response to the triggering event being detected.

6. The method of claim 5, wherein the triggering event is at least one of a battery of the mobile device dropping below predetermined battery power level, a rate of power consumption exceeding a predetermined power consumption threshold, and a location of the mobile device being with a predetermined area.

7. The method of claim 1, further comprising:
monitoring and storing battery power consumed during the boot sequence and an operational phase of the mobile device;
determining a boot mode power estimate number associated with the target mode based on the monitored battery power consumed; and
displaying the boot mode power estimate number with the target mode.

8. The method of claim 1, further comprising:
monitoring and storing battery power consumed during boot sequences and an operational phases of the mobile device associated with each of the plurality of boot modes;
determining a plurality of boot mode power estimate numbers based on the monitored battery power consumed during the boot sequences and the operational phases of the mobile device associated with each of the plurality of boot modes, each boot mode power estimate number corresponding to a corresponding boot mode of the plurality of boot modes; and
displaying each of the plurality of boot mode power estimate numbers with the corresponding boot mode.

9. The method of claim 1, wherein the plurality of boot sequence modes comprises two or more of an emergency mode, a voice-only mode, a text-only mode, a data-only mode, a location-only mode, and a normal mode.

10. The method of claim 9, wherein the emergency mode enables initialization of at least one of resources associated with a modem, vocoder, telephony services, at least one dialer application, at least one SOS-based application, and at least one location-based application.

11. The method of claim 9, wherein the voice-only mode enables initialization of at least one of resources associated with a modem, vocoder, Wi-Fi, at least one dialer application, and at least one contact application.

12. The method of claim 9, wherein the text-only mode enables initialization of at least one of resources associated with a modem, vocoder, at least one short message service (SMS) application, and at least one contact application.

13. The method of claim 9, wherein the data-only mode enables initialization of at least one of resources associated with a modem, Wi-Fi, and at least one application requiring data.

14. The method of claim 9, wherein the location-only mode enables initialization of at least one of resources associated with a geo-location device, Wi-Fi, modem, and at least one map application.

15. The method of claim 9, wherein the normal mode enables initialization of all hardware and software resources of the mobile device.

16. The method of claim 1, further comprising executing at least one prior boot sequence segment prior in the boot sequence to the first boot sequence segment, wherein the first boot sequence segment is executed at the completion of executing the at least one prior boot sequence segment.

17. The method of claim 1, further comprising executing at least one subsequent boot sequence segment subsequent in the boot sequence to the first boot sequence segment, wherein the at least one subsequent boot sequence segment is executed at the completion of executing the first boot sequence segment.

18. An apparatus for booting up a mobile device, the apparatus comprising:
means for segmenting a boot sequence of the mobile device into a plurality of boot sequence segments;
means for determining a first boot sequence segment from the plurality of boot sequence segments, wherein a battery power consumption of the first boot sequence segment exceeds a threshold;
means for selecting a target boot mode from a plurality of boot modes, wherein each of the plurality of boot modes enables at least some but not all resources of the mobile device;
means for executing the first boot sequence segment when the target boot mode is implemented; and
means for executing at least one of the plurality of boot sequence segments other than the first boot sequence segment when a normal mode is implemented, wherein the normal mode enables all resources of the mobile device.

19. A mobile device comprising:
a memory; and
at least one processor coupled to the memory and configured to:
segment a boot sequence of the mobile device into a plurality of boot sequence segments;
determine a first boot sequence segment from the plurality of boot sequence segments, wherein a battery power consumption of the first boot sequence segment exceeds a threshold;
select a target boot mode from a plurality of boot modes, wherein each of the plurality of boot modes enables at least some but not all resources of the mobile device;
execute the first boot sequence segment when the target boot mode is implemented; and
execute at least one of the plurality of boot sequence segments other than the first boot sequence segment when a normal mode is implemented, wherein the normal mode enables all resources of the mobile device.

20. The mobile device of claim 19, wherein the at least one processor is further configured to:
monitor, for each of the plurality of boot sequence segments, battery power consumption associated with two or more boot instances;
determine, for each of the plurality of boot sequence segments, battery power consumption characteristics based on the battery power consumption associated with the two or more boot instances; and
determine the first boot sequence segment based, at least in part, on the battery power consumption characteristics.
